(19) United States
(12) Patent Application Publication
(10) Pub. No.: US 2026/0074958 A1
(43) Pub. Date: Mar. 12, 2026

(54) PRESERVING PRIVACY IN GENERATING A PREDICTION MODEL FOR PREDICTING USER METADATA BASED ON NETWORK FINGERPRINTING

(71) Applicant: ANAGOG LTD., Tel Aviv (IL)

(72) Inventors: Ilan MALKA, Tel Aviv (IL); Igor PECHERSKY, Karney Shomron (IL)

(21) Appl. No.: 18/871,719

(22) PCT Filed: Jun. 4, 2023
(86) PCT No.: PCT/IL2023/050572

§ 371 Date: Dec. 4, 2024

Related U.S. Application Data
(60) Provisional application No. 63/365,888, filed on Jun. 6, 2022.

(51) Int. Cl. H04L 41/147; H04L 41/14; H04L 41/16

(52) U.S. Cl. CPC H04L 41/147; H04L 41/145; H04L 41/16

(57) ABSTRACT

A method, an apparatus and a computer program product for machine learning based on network fingerprinting, while preserving privacy in generating a prediction model for predicting user metadata. Routing information of a device is obtained based probe packets sent by the device to a server that is connectable to the device via the Internet, such as a series of packet hops implemented to route the packets to the server or a series of Internet Protocol (IP) addresses of the series of packet hops until reaching the Internet. A fingerprint describing an architecture of connection path of the device to the Internet is created based on the routing information. The prediction model is trained using training dataset that includes pairs of fingerprints and labels using edge devices having known labels, that are indicative of a routing information of an edge device to the Internet.

### CROSS-REFERENCE TO RELATED APPLICATION

This application is a non-provisional of and claims the benefit of U.S. Provisional Application No. 63/365,888 filed Jun. 6, 2022, entitled “CLIENT-BASED NETWORK FINGERPRINTING” which is hereby incorporated by reference in its entirety without giving rise to disavowment.

### TECHNICAL FIELD

The present disclosure relates to machine learning in general, and to machine learning based on client-based fingerprinting, in particular.

### BACKGROUND

Machine learning is a powerful technology that can be used to personalize services for users. By analyzing user behavior and preferences, machine learning algorithms can provide personalized recommendations, improve search results, and tailor user interfaces to individual users. Personalization can lead to increased engagement and satisfaction, as well as better retention rates for users. However, the use of machine learning also raises privacy concerns that must be addressed to ensure the protection of users'personal information.

One of the main privacy concerns associated with machine learning is data privacy. Machine learning algorithms require large amounts of data to train effectively, and this data often includes sensitive information such as user identifiers, user location, browsing history, and purchasing behavior. It is essential that organizations collecting user data have clear policies and procedures for data collection, storage, and use, and that users are provided with transparent and easily understandable information about how their data is being used.

Another privacy concern associated with machine learning is the potential for algorithmic bias. Machine learning algorithms are only as objective as the data they are trained on, and if the data contains biases, the algorithm may perpetuate them. This can result in discriminatory outcomes for certain users or groups of users. To mitigate this risk, organizations should adopt best practices such as diverse and representative data sets, algorithmic transparency, and regular auditing of algorithms for bias.

Finally, there is the issue of user consent. Users must have the ability to control how their data is collected, stored, and used, and must be given clear and meaningful choices about what data they are willing to share. Organizations must ensure that their privacy policies are accessible and understandable, and that users are provided with the necessary tools and information to exercise their privacy rights. Failure to obtain proper user consent can result in legal liabilities and reputational damage for organizations.

### BRIEF SUMMARY

One exemplary embodiment of the disclosed subject matter is a method comprising: obtaining routing information of a device, wherein the routing information is obtained based on one or more probe packets sent by the device to a server that is connectable to the device via the Internet, whereby a series of packet hops was implemented to route the one or more probe packets to the server, the routing information includes a series of Internet Protocol (IP) addresses of the series of packet hops until reaching the Internet; creating, based on the routing information, a fingerprint describing an architecture of connection path of the device to the Internet; and utilizing a prediction model to determine a label for the fingerprint, wherein the label is indicative of metadata of a user of the device, wherein the prediction model is trained using training dataset that includes pairs of fingerprints and labels using edge devices having known labels, the fingerprints of the training dataset are indicative of a routing information of an edge device to the Internet.

The method of Claim 1, wherein the fingerprint comprises the series of Internet Protocol (IP) addresses of the series of packet hops or an encoding thereof.

The method of Claim 1, wherein the fingerprint comprises IP addresses associated with N consecutive packet hops from the device in accordance with the routing information.

The method of Claim 1, wherein a similarity between two fingerprints is determined based on a size of an identical subset of consecutive packet hops.

The method of Claim 1, wherein said utilizing the prediction model is performed on the device, to predict the label for the device without exposing the fingerprint to an external device.

The method of Claim 5 further comprises augmenting prediction of label for the fingerprint using additional features gathered at the device, wherein the additional features are not available to the external device.

The method of Claim 1, wherein the prediction model is generated using centralized learning performed on a central server, wherein the training dataset comprises multiple training data, each of which are obtained from a different edge device.

The method of Claim 7, wherein each training data obtained from a respective edge device is processed to replace a permanent identifier of the respective edge device with a transient identifier prior to being sent to the central server, whereby preserving privacy of data of the respective edge device.

The method of Claim 1, wherein the training dataset includes a partly fabricated training data that was reported by a training edge device, the training edge device having a known correct label, the partly fabricated training data comprises a fingerprint of the training edge device that is paired with several labels, the several labels include the known correct label and at least one incorrect label, whereby preserving the privacy of data of the training edge device during the training process.

The method of Claim 1, wherein the training dataset includes a partly fabricated training data that was reported by a training edge device, the training edge device having a known correct label and a known correct fingerprint, the partly fabricated training data comprises at least a first pair and a second pair, the first pair comprising the known correct fingerprint and the known correct label, the second pair comprising a fabricated fingerprint and the known correct label, whereby preserving a privacy of data of the training edge device during the training process.

The method of Claim 1, wherein the training dataset comprises pairs of fabricated fingerprints and labels, wherein a fabricated fingerprint is generated by modifying an IP address of at least one packet hop in the connection path.

The method of Claim 1, wherein the training dataset includes a partly fabricated training data, wherein fabrication of training data is performed below a predetermined threshold, thereby enabling the prediction model to predict correct labels despite fabricated and incorrect information.

The method of Claim 1, wherein the prediction model is generated using federated learning performed on a central server, wherein each edge device provides a model update to the predictive model based on pairs of fingerprints and labels available to the edge device, whereby obfuscating training data generated by the respective edge device.

Another exemplary embodiment of the disclosed subject matter is an apparatus comprising a processor and coupled memory, said processor being adapted to: obtain routing information of a device, wherein the routing information is obtained based on one or more probe packets sent by the device to a server that is connectable to the device via the Internet, whereby a series of packet hops was implemented to route the one or more probe packets to the server, the routing information includes a series of Internet Protocol (IP) addresses of the series of packet hops until reaching the Internet; create, based on the routing information, a fingerprint describing an architecture of connection path of the device to the Internet; and utilize a prediction model to determine a label for the fingerprint, wherein the label is indicative of metadata of a user of the device, wherein the prediction model is trained using training dataset that includes pairs of fingerprints and labels using edge devices having known labels, the fingerprints of the training dataset are indicative of a routing information of an edge device to the Internet.

Yet another exemplary embodiment of the disclosed subject matter is a computer program product comprising a non-transitory computer readable medium retaining program instruction, which program instructions when read by a processor, cause the processor to: obtain routing information of a device, wherein the routing information is obtained based on one or more probe packets sent by the device to a server that is connectable to the device via the Internet, whereby a series of packet hops was implemented to route the one or more probe packets to the server, the routing information includes a series of Internet Protocol (IP) addresses of the series of packet hops until reaching the Internet; create, based on the routing information, a fingerprint describing an architecture of connection path of the device to the Internet; and utilize a prediction model to determine a label for the fingerprint, wherein the label is indicative of metadata of a user of the device, wherein the prediction model is trained using training dataset that includes pairs of fingerprints and labels using edge devices having known labels, the fingerprints of the training dataset are indicative of a routing information of an edge device to the Internet.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an illustration of a network architecture, in accordance with some exemplary embodiments of the subject matter;

FIG. 2 shows a flowchart diagram of a method, in accordance with some exemplary embodiments of the disclosed subject matter;

FIGS. 3A-3B show flowchart diagrams of methods, in accordance with some exemplary embodiments of the disclosed subject matter; and

FIG. 4 shows a block diagram of an apparatus, in accordance with some exemplary embodiments of the disclosed subject matter.

### DETAILED DESCRIPTION

One technical problem dealt with by the disclosed subject matter is identifying similar users based on their metadata. In some cases, users that originate from the same Internet Protocol (IP) address may be determined to be within the same network. However, due to standard networking techniques, the IP address of the client may appear to be different than its actual IP address and may be indicative of the Internet Service Provider (ISP) server, the router, or the like.

Different people can have similar attributes related to e.g., interests, age, gender, home place, workplace, income level, or the like. It may also be possible to define a group of people that have one or more common or similar attributes such as profession, income level, field of interest, or the like. As an example, a group of users may be associated with “High-income level”, and may be classified as “Students”, “Lawyers”, “Sports addicts”, or the like. Those similarities may be derived from the behavior of the users, the places they live, the places they work, their interests, or the like.

One technical solution is to predict the metadata of users based on a client-based networking fingerprinting that describes the architecture of a shared network to detect shared attributes. In some exemplary embodiments, a fingerprint describing an architecture of the connection path of a device to the Internet may be created for each device based on the routing information the device provides. The routing information may comprise one or more probe packets sent by the device to a server that is connectable to the device via the Internet, such as a traceroute. As an example, the trace route may be traced based on a Trace TCP/IP Route (TRCTCPRTE) command configured to trace the route of IP packets to a user-specified destination system. The trace route may comprise a series of packet hops that were implemented to route one or more probe packets to the server. The routing information may comprise a series of IP addresses of the series of packet hops until reaching the Internet.

In some exemplary embodiments, machine learning that is based on client-based fingerprinting information may be utilized to deduce labels about users. As an example, the label may be workplace identity, e.g., company, a specific Office/Department within the company, or the like. As another example, the label may be a combination of attributes related to demographic information, such as age, gender, place of residence, or the like. As yet another example, the label may be related to other types of data, such as interests, income level, political opinions, socioeconomic status, or the like. Additionally or alternatively, groups of people sharing a certain label may be defined to have one or more similar attributes, such as “sports addicts” sharing the same interest, shopping habits, or the like. The similarities may be derived from the shared behavior of members of the group, such as their residence location, living style, workplaces, interests, or the like. By segmenting the labeling into such general groups, infringing the privacy of the users may be avoided. Such grouping may be derived from user proximity determined based on network fingerprinting.

In some exemplary embodiments, the fingerprint may comprise raw features associated with the connection path of a device to the Internet, such as the first predetermined number of IP addresses in the route from the device to some external address. The features may indicate the first hop, the second hop, the third hop, . . . the n^{th} hop when routing a packet from the edge device to the Internet or to a specific server.

In some exemplary embodiments, a similarity between two fingerprints may be determined based on a size of an identical subset of consecutive packet hops, such as the size of identical suffixes in the fingerprint. As the size of an identical suffix in the path represented by the fingerprint increases, the geographical proximity of the users may be considered as increased.

In some exemplary embodiments, a prediction model may be utilized to determine a label for the fingerprint, that is indicative of metadata of a user of the device. As an example, users that are employed by the same company and located in the same company site may share the same Local Area Network (LAN) as their gateway. As another example, users that are employed by the same company may share the same LAN even if they work out of different company sites. As yet another example, students residing in the same dorms on the same campus may share the same Metropolitan Area Network (MAN). As yet another example, clients of the same ISP that are located in the same neighborhood may be likely to share similar socio-demographic attributes, such as education level, ethnicity, age group, income level, or the like.

In some exemplary embodiments, each edge device may send probe packets into the network it is located therein, to determine routing information. The edge device may detect routers and network devices within the network until reaching a server, the Internet, or the like. A fingerprint describing the architecture of the route within the network may be created. In some exemplary embodiments, the fingerprint may comprise the series of IP addresses of the series of packet hops, an encoding thereof, or the like. Additionally or alternatively, the fingerprint may comprise IP addresses associated with a predetermined number g consecutive packet hops from the device in accordance with the routing information. As edge devices connected to the same ISP provider may perform the same detection, devices that are sharing the same network may generate similar or close fingerprints based on their proximity to each other.

In some exemplary embodiments, the prediction model may be trained using a training dataset that includes pairs of fingerprints generated for edge devices having known labels, and indicative of routing information of the edge devices to the Internet, such as devices of users with known workplace identity, when the edge device is within the workplace LAN or the like. The edge-based fingerprint may be utilized with the known workplace identity as part of a learning dataset that is used to train the prediction model. The prediction model may include, directly or indirectly, a set of rules over specific values of features (raw and/or derived) of the fingerprint, their patterns (regexes, sequences), or the like, to distinguish each workplace identity from all the rest.

In some exemplary embodiments, the prediction model may be generated using centralized learning performed on a central server. The training dataset utilized to train the prediction model may comprise multiple training data, each of which is obtained from a different edge device. The training data may comprise fingerprints as features and metadata of the users as labels. In some exemplary embodiments, some transformation, such as anonymization, PII removal process, or the like, may be applied prior to sending the information to the server. Additionally or alternatively, the training data obtained from a respective edge device may be processed to replace a permanent identifier of the respective edge device with a transient identifier prior to being sent to the central server, to preserve the privacy of data of the respective edge device. The central server may be configured to train and generate the prediction model in a centralized location, without being exposed to PII information.

It may be noted that the prediction is performed on the device, while the model is trained in centralized training or federated training, to enable predicting the label for the device without exposing the fingerprint to any external device, including the entity providing the model.

In some exemplary embodiments, the training dataset may eb augmented by partly fabricated training data generated based on data reported by a training edge device. While the training edge device having a known correct label, the partly fabricated training data may comprise a fingerprint of the training edge device that is paired with several labels, including the known correct label with additional incorrect label. This may enable preserving the privacy of data of the training edge device during the training process. Additionally or alternatively, the partly fabricated training data may be generated by fabricating the fingerprint and providing it with the known correct label. The fabricated fingerprint may be generated by modifying an IP address of at least one packet hop in the connection path. It may be noted that fabrication of the training data is performed below a predetermined threshold, to enable the prediction model to predict correct labels despite fabricated and incorrect information.

Additionally or alternatively, the prediction model may be generated using federated learning performed on the central server. Each edge device may be configured to provide a model update to the predictive model based on pairs of fingerprints and labels available to the edge device, without exposing training data generated by the respective edge device.

One technical effect of the disclosed subject may be preserving the privacy of the data of the edge devices and users thereof while using device routing information to predict metadata of a user of the device, both in collecting training data and while applying the prediction model. When the prediction model is generated using centralized machine learning, this is achieved by replacing permanent identifiers with transient identifiers, partly fabricating training data, and limiting the fabrication of training data below a certain threshold. When the prediction model is generated using federated machine learning, each of the edge devices may be configured to provide updates to the prediction model based on local training without exposing identifying information of the user or the device. The prediction is further augmented using additional features gathered at the device, which are not available to external devices or to the server generating the prediction model. Additionally or alternatively, the prediction model is generated using a centralized machine learning approach, the prediction model may be trained using a large amount of diverse data from multiple edge devices, which improves the accuracy of the prediction model and enable better predictions.

Another technical effect of the disclosed subject matter may be creating a fingerprint of the device's connection path to the internet, based on the routing information obtained from probe packets sent by the device, without requiring a geographical location of the device.

Yet another technical effect of the disclosed subject matter may be enabling inferring, by the prediction model correct information, while providing fabricated information. The fabricated information is generated in a manner making it challenging to differentiate between the true and fabricated information, as the fabrication is performed in different levels and sophisticated methods, such as the fabrication of the fingerprints in several methods without affecting the correct label. Furthermore, given a correct ratio between different fabricated training data and true data, in accordance with the size of the training dataset, the prediction model may be trained using wider training datasets, without compromising the privacy of edge devices, requiring accurate or private information therefrom, or the like; and still, be capable of predicting the correct label for each fingerprint.

The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

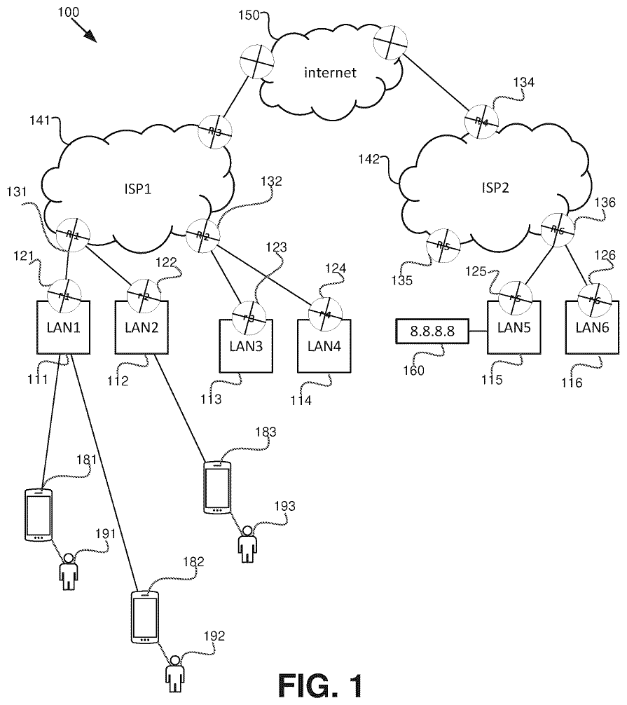

Referring now to FIG. 1 showing an illustration of a network architecture, in accordance with some exemplary embodiments of the subject matter.

A Network 100 may consist of multiple edge devices such as Device 181, Device 182, and Device 183; connected to local area networks (LANs), such as LAN 111-LAN 116. The LANs may be connected via Routers (121-126, 131-136) to ISPs (e.g., metropolitan networks (MANs), wide area networks (WANs)) such as ISP 141 and ISP 142, and eventually to the public Internet 150. Network 100 serves as a model for implementing the proposed methods of utilizing network fingerprinting and machine learning for predicting target labels. As an example, in Network 100, LAN 111 may be connected to ISP 141 via Router 121 and Router 131. Edge Devices 181-183 may be connected to LANs 111-113, respectively. Each LAN 111-116 may be connected to one or more Routers 121-126, respectively. Routers 121-126 may be configured to provide connectivity between the respective LANs 111-116 and the public Internet 150.

In some exemplary embodiments, machine learning may be utilized to deduce labels indicative of information about Users 191-193, such as workplace identity, proximity to certain locations, interests, age, gender, or the like by analyzing the network fingerprint of each device. An edge device may constantly, or per request, send probe packets into the network it is in. The edge device detects routers and network devices within the network. Edge Devices 181-183 of User 191, User 192, and User 193 may be configured to check routing information to a designated Server 160 (e.g., located at IP address “8.8.8.8”). Based on the detected path, it may be deduced whether the device is located within the same LAN network as other devices or in different networks, and deduce information about the users of the edge devices. As an example, when Device 181 of User 191 that is connected to LAN 111 checks routing information to Server 160, the detected path may be user1->r1->R1->R3->public internet where user1 refers to the hop of Device 181, r1 refers to the hop of Router 121 of LAN 111 connected to ISP 141 via R1 which refers to the hop of Router 131, and R3 which refers to the hop of ISP 141 connecting to public Internet 150. As another example, when Device 182 of User 192 that is connected to LAN 111 checks routing information to Server 160, the detected path may be user2->r1->R1->R3->public internet where user1 refers to the hop of Device 182, r1 refers to the hop of Router 121 of LAN 111 connected to ISP 141 via R1 which refers to the hop of Router 131, and R3 which refers to the hop of ISP 141 connecting to public Internet 150. As yet another example, when Device 183 of User 193 that is connected to LAN 112 checks routing information to Server 160, the detected path may be user3->r2->R1->R3-> public internet where user3 refers to the hop of Device 183, rl refers to the hop of Router 121 of LAN 111 connected to ISP 141 via R1 which refers to the hop of Router 131, and R3 which refers to the hop of ISP 141 connecting to public Internet 150. Using the detected network path, it may be deduced that User 191 and User 192 are both located within the same LAN 111 (e.g., in the same home/office/corporate). User 193, on the other hand, who uses a different LAN 112 (hence r2 is identified as the first hop as opposed to r1), but within the same physical area (e.g., same neighborhood, city, or the like), as both of their respective LANs (r1, r2) are connected to the same metropolitan network of R1.

In some exemplary embodiments, the machine learning (training and prediction) may be based on client-based fingerprinting information to deduce labels about users. A unique fingerprint describing the architecture of the connectivity within Network 100 may be created for each edge device. The fingerprint may be utilized as raw features for the machine learning process. In some exemplary embodiments, the fingerprint may comprise the first predetermined number (e.g., 5, 8, 10, or the like) of IP addresses in the route from the device to the Internet 150 or a specific server, such as Server 160, an encoding thereof, or the like. As an example, in one embodiment 6 hop information may be obtained. The following values may indicate raw features of a specific edge device which requires only five hops to reach the Internet: 1^{st} hop: 192.168.1.1, 2^{nd} hop: 212.179.37.1, 3^{rd} hop: 10.250.41.6, 4th hop: 212.25.77.6, 5^{th} hop: 10.250.31.5 and 6^{th} hop: n/a. Using client-based fingerprinting information, machine learning may be utilized to deduce labels about users. As an example, the target label may be workplace identity, e.g., company, specific office or department within the company, or the like. Additionally or alternatively, features derived from the raw features may also be used, such as parts of raw features, tuples of consequent raw features or the like. Assuming all users connected to the same ISP provider will perform the same detection, devices that are sharing the same network will generate similar or close fingerprints based on their proximity to each other. Since LAN/MAN networks are restricted in size, we can assume that devices that generate the same or similar fingerprints may be also geographically close to each other.

In some exemplary embodiments, federated learning may be implemented, allowing the model to be built on many participating devices in several rounds. It may be distributed among devices; each device updates the model with its own labels and features and sends the model update back to the central server. The central server aggregates those updates into the global model, and redistribute it among participating device for the next round of model updates. To preserve user privacy, techniques such as noisy features and random noise may be introduced to prevent user tracking on Server 160. As an example, temporary user IDs may be used instead of permanent Ids of Users 191-193 when providing the data for training or execution of the machine learning model. As another example, fabricated features or random noise may be introduced to the features when reporting the true label and fingerprint information. As another example, fabricated labels or random noise may be introduced to the labels while reporting true features. After a model is generated, the model may be utilized, either at the server or on the edge devices, to predict a target for a specific device given its network fingerprint.

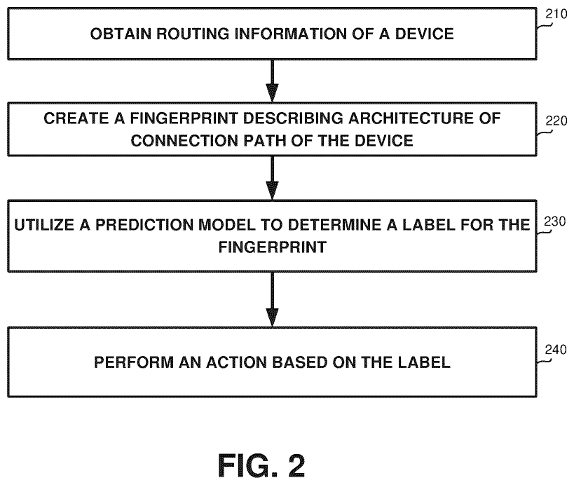

Referring now to FIG. 2 showing a flowchart diagram of a method, in accordance with some exemplary embodiments of the disclosed subject matter.

On Step 210, routing information of a device may be obtained. In some exemplary embodiments, the routing information may be obtained based on one or more probe packets sent by the device to a server that is connectable to the device via the Internet. The route may involve different systems along the way, connecting to different networks, devices, or the like. Each system or element along the route is referred to as a packet hop. The packet hops may be traced along the route. Additionally or alternatively, starting and ending packet hops may be specified to be traced. A series of packet hops that were implemented to route one or more probe packets to the server may be obtained. The route may be traced by sending packets (or probes) to the destination system. Each probe may contain a hop limit or an upper limit (called Time To Live or TTL) on the number of packet hops the probe can pass through. A route may be traced by successively incrementing the TTL of the probe packets by one packet hop. The trace ends when either a probe response is received from the destination system or when the probe TTL value equals the maximum allowed. Responses from the probe packets may be sent as messages to the job log or as queue entries to a user-specified data queue. Additionally or alternatively, the routing information may include a series of

On Step 220, a fingerprint describing an architecture of the connection path of the device to the Internet may be created based on the routing information. In some exemplary embodiments, the fingerprint may be configured to map the arbitrarily large architecture of the connection path of the device to the Internet to a much shorter bit string, that uniquely identifies the original data for all practical purposes just as human fingerprints uniquely identify people for practical purposes. The fingerprint may be used for data deduplication purposes. As an example, the fingerprint may comprise a concatenation of IP addresses of the series of packet hops until reaching the Internet or an encoding thereof. As another example, the fingerprint may comprise IP addresses associated with N consecutive packet hops from the device in accordance with the routing information.

On Step 230, a prediction model may be utilized to determine a label for the fingerprint. In some exemplary embodiments, the label may be indicative of metadata of a user of the device, such as a workplace (company, office, department), shopping habits, interests, outcome, or the like. The prediction model may be configured to predict labels based on the similarity between fingerprints, which may be determined based on a size of an identical subset of consecutive packet hops.

It may be noted that the prediction model may be utilized on the device side, to predict the label for the device without exposing the fingerprint to an external device such as the central server performing the training, or the like. Additionally or alternatively, the prediction of the label for the fingerprint may be augmented using additional features gathered at the device, that may not be available to the external device.

On Step 240, an action may be performed based on the label. The action may vary depending on the specific use case and application, the metadata determined based on the label, or the like. In some exemplary embodiments, the action may be a personalization action, in which the metadata can be used to personalize the user experience, such as by providing targeted content or recommendations based on the user's interests and behavior. Additionally or alternatively, the action may be a marketing action in which the metadata can be used for marketing purposes by analyzing the user's behavior and preferences to create targeted advertisements and promotions. Additionally or alternatively, the action may be a security-related action, such as detecting anomalies in user behavior and flagging potential security threats. Additionally or alternatively, the action may be a network optimization action that optimizes the network performance by analyzing traffic patterns based on the metadata and adjusting network resources accordingly. Additionally or alternatively, the ACTION may be a service optimization in which the metadata is utilized used to optimize service delivery by analyzing user behavior and preferences to improve service quality and reduce churn.

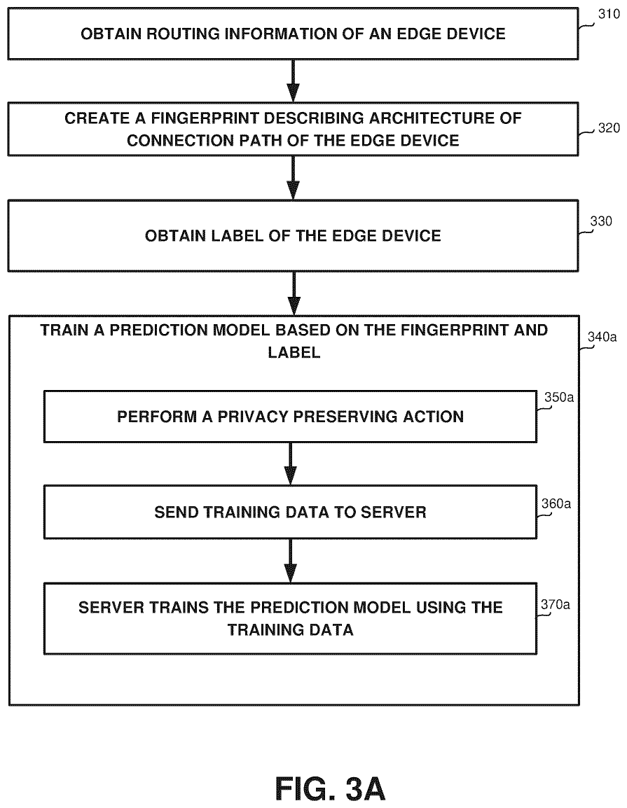

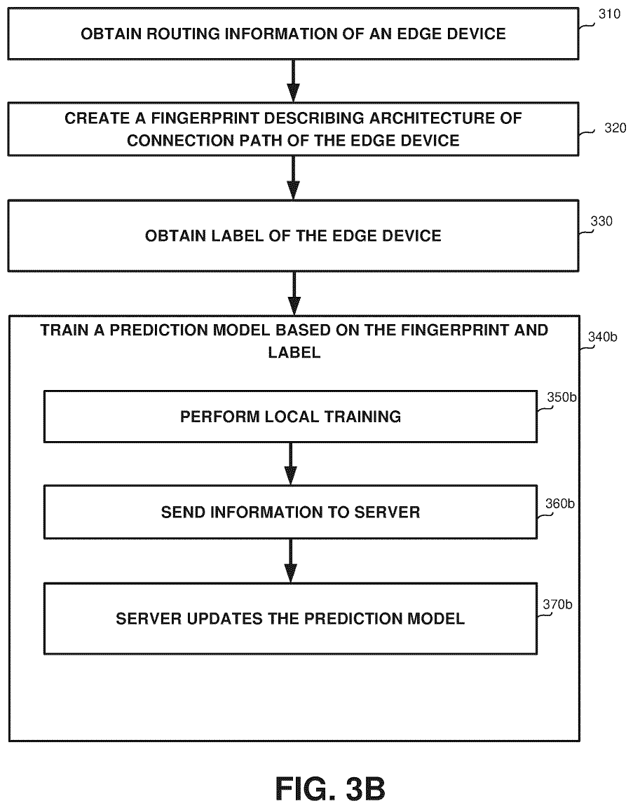

Referring now to FIG. 3A showing a flowchart diagram of a method, in accordance with some exemplary embodiments of the disclosed subject matter.

On Step 310, routing information of an edge device may be obtained. In some exemplary embodiments, the routing information may be obtained based on one or more probe packets sent by the device to a server that is connectable to the device via the Internet, a series of packet hops that was implemented to route the one or more probe packets to the server, a series of IP addresses of the series of packet hops until reaching the Internet, or the like.

On Step 320, a fingerprint describing an architecture of the connection path of the edge device to the Internet may be created based on the routing information. The fingerprint may be generated based on the series of IP addresses of the series of packet hops, such as a concatenation thereof, an encoding thereof, a hashing thereof, or the like. Additionally or alternatively, the fingerprint may be generated based on a portion of the IP addresses of the series of packet hops, such as the IP addresses associated with a predetermined number of consecutive packet hops from the device in accordance with the routing information, a prefix or a suffix thereof, a predetermined number of starts hops and a predetermined number of end hops (close to the public Internet), or the like.

It may be noted that Steps 210 and 220, which relate to the execution of the prediction model may be performed in a similar, uniform manner as Steps 310 and 320 performed in the training phase. Additionally or alternatively, the fingerprints may be augmented or modified based on additional features gathered at the device that are not available in the training phase.

On Step 330, a label of the edge device may be obtained. The label may be indicative of metadata of a user of the device, such as demographical attributes, interests, income level, or the like. In some exemplary embodiments, the label may be provided directly by the device. Additionally or alternatively, the label may be deduced or determined based on other attributes, artificially generated, or the like.

On Step 340a, a prediction model may be trained in centralized learning using a training dataset that includes a pair of the fingerprint and the label. In some exemplary embodiments, the training dataset may comprise multiple pairs of fingerprints and labels obtained from different edge devices having known labels. The training data may be processed on the central server, which is configured to train the prediction model using the combined training data provided by the edge devices. The central server applies machine learning algorithms to train the prediction model, such as neural networks, decision trees, or support vector machines to process the training data and train the prediction model.

It may be noted that in centralized learning, the edge devices are not required to perform any machine learning themselves, but only provide data to the central server. However, each edge device may be capable of performing transformations on the training data before providing it to the centralized server. These transformations may include randomizing the data to preserve privacy, anonymizing the data to remove personally identifiable information, or aggregating the data to protect sensitive information. These transformations help to protect the privacy of the users and the sensitive information of the edge devices while still allowing the central server to obtain useful training data.

On Step 250a, the edge device may perform a privacy-preserving action. In some cases, the training data (e.g., each pair of the fingerprint and the label) may be reported from the edge devices after performing some transformation or processing thereof on the edge device, while the prediction model is being trained on a central server, to be distributed to and applied on all devices. Such transformation or processing may be performed in order to preserve the privacy of the data of the edge device.

One exemplary privacy-preserving action may be processing the training data, such as by the edge device or by another device, to replace a permanent identifier (e.g., User IDs) of the edge device with a transient identifier prior to being sent to the central server, whereby preserving the privacy of data of the respective edge device. Such action may be performed to prevent user tracking on the server. It may be noted that the permanent identifiers may not be used in the learning process in Step 370a by themselves. However, permanent identifiers may still be utilized to prevent data bias and/or poisoning. In some exemplary embodiments, temporary identifies may be generated and utilized, as is disclosed in U.S. Patent Publication No. 2021/0397744, entitled “Privacy-preserving data collecting”, which is hereby incorporated by reference in its entirety without giving rise to disavowment Another privacy-preserving action may be introducing partly fabricated training data to the server. The partly fabricated training data may be generated based on true data reported by the edge device. While the true data, available only to the edge device may have a known correct label, and a known correct fingerprint, the partly fabricated training data may comprise the true fingerprint of the training edge device paired with several alternative labels, that include the known correct label and at least one incorrect label. The incorrect labels, e.g., fabricated labels, may be generated based on the correct label, such as by introducing random noise to the correct labels.

Additionally or alternatively, the partly fabricated training data may comprise the known correct label paired with several alternative fingerprints that include the known correct fingerprint and at least one incorrect fingerprint. The incorrect fingerprint, e.g., fabricated fingerprints may be generated based on the correct fingerprint, such as by modifying an IP address of at least one packet hop in the connection path.

Additionally or alternatively, instead of reporting plain features (fingerprints) and labels, a locality-sensitive hashing (LSH) algorithmic technique may be utilized thereon, such as deriving 2D features from LSH fingerprint. LSH may be configured to hash similar training pairs (e.g., pairs sharing similar fingerprints, pairs sharing similar labels, or the like) into the same “buckets” with high probability Additionally or alternatively, other hashing methods may be utilized for feature hashing, such as data-independent methods, data-dependent methods, such as locality-preserving hashing (LPH), fuzzing hash (TLSH), or the like. As an example, a family of hash functions id may be used to encode features and/or labels into vectors of hash values. Due to the high collision rate per each specific hash function, the transformation may be non-invertible. As an example, the hash functions may comprise last 1 digit of MD5 (salt prepended to IP address), with salt [“a”,“b”,“c”, “d”]. By aggregation of the output of all functions, the resulting space for the set of IP addresses (their order is of no importance) is a 16-dimensional integer (counts). So, for 212.179.37.1 hash is (0,f,1,9), and for 192.168.1.1 (6,d,8,9). For set (192.168.1.1,212.179.37.1) the result is (1,1,0,0,0,0,1,0,1,2,0,0,0,1,0,1). Additionally, or alternatively, each IP address may be preprocessed by stemming, masking, or the like. As an example, IP address 212.179.37.1 may be transformed into set (212.179.37.1, 212.179.37.0, 212.179.0.0). The feature hashing may then be applied to the union of sets derived from all IP addresses in the input. In some cases the stemming or masking of the IP address may be performed prior to hashing. As an example, IP address “11.12.13.14” may be stemmed into the set “11.12.13.14”, “11.12.13.”, “11.12. ”, prior to performing the hashing.

As another example, generated fingerprints may comprise lists of IP addresses that are concatenated in dot-decimal, comma-delimited, or the like. a TLSH, or any other similar local-sensitive hash functions, may be applied on the whole fingerprints. So, for “192.168.1.1,212.179.37.1,10.250.41.6,212.25.77.6,10.250.31.5” the hash may be T1D2A002E3420096A11CCA1584DC128827916D94B31176D090AB7BB7035DOD2C06 148760. Such hash may immediately be appropriate for nearest-neighbor search (over bitwise Hamming distance for example), for 70-dimensional multi-class GBM, or the like.

It may be noted that the proposed algorithm may provide one-side plausible deniability. Namely, the possibility of collisions in the hash space allows to deny, given the resulting fingerprint, the presence on any given IP address in the device traceroute. If, in some exemplary embodiments, a stricter level of plausible deniability, or/and two-sides plausible deniability (ability to deny both presence and absence on any given IP address in the device traceroute) is desired, then exclusive or (XOR) Bernoulli noise may be added to the resulted hash bit-array before subsequent processing, such as sending to the server. As an example, assuming that the hash was calculated to be “A1E4”, and the noise probability set to 0.1, the generated noise may be 0010000000000001. Then the XOR of hash and noise is “81E5”, and this value may be subsequently used as a fingerprint in downstream tasks.

It may be noted that the fabrication of training data is required to be performed below a predetermined threshold, to enable the prediction model to predict correct labels despite fabricated and incorrect information.

On Step 360a, the training data may be sent to the server. In some exemplary embodiments, the training data may comprise a combination of true and fabricated pairs. As an example, the training data may comprise at least a first pair, a second pair, and a third pair. The first pair may comprise the known correct fingerprint and the known correct label, as being determined by the edge device. The second pair may comprise a fabricated fingerprint and the known correct label. The third fingerprint may comprise the known correct fingerprint with a fabricated label. Additionally or alternatively, the training data may comprise true data, partially fabricated data, obfuscated data, hashed data, or the like. It is noted that differentiating between the true training pairs and fabricated training pairs may be a challenging task, as the information of the internal hop addresses may be hard to validate and may not be accessible to external agents.

In some exemplary embodiments, instead of reporting the correct label, a probability matrix of several labels may be reported for each true correct fingerprint. As an example, the correct label may be reported together with 3 additional wrong labels, each at a probability of 25%. Given a sufficiently large amount of data, the prediction model may disregard the noise and infer correct information based on the fact that each edge device reported the true label together with some randomly generated labels, which are different for edges that share the same true label. Additionally or alternatively, the fabricated reports may be performed with a predetermined probability in accordance with the training dataset size, such as 50:50 for two reports, 25:25:25:25 for four reports, or the like. Given a sufficiently large amount of training, the model may disregard the noise and infer correct information.

Additionally or alternatively, random noise may be injected by the edge device into the reported training data prior to being provided to the central server. The random noise may be utilized to obfuscate the edge device's contribution in an additional manner. It may be noted that the noisy/fake training data generated using random noise introduced to the training data as a whole may be indistinguishable from the real or true training data, even more than when introducing noise to the fingerprints or the labels, separately, e.g., Noisy Target and Noisy Features as performed in Step 250a, may be more practically feasible, or the like.

On Step 370, the server may train the prediction model using the training data. In some exemplary embodiments, the model may be trained to associate each device based on its routing information with a specific label. Additionally or alternatively, the model may be trained to associate each fingerprint with a label.

Referring now to FIG. 3B showing a flowchart diagram of a method, in accordance with some exemplary embodiments of the disclosed subject matter.

On Step 340b, a prediction model may be trained in federated learning. Federated learning may be a machine learning technique that trains the prediction model via multiple independent sessions, on separated devices, each using its own dataset.

In some exemplary embodiments, a centralized federated learning may be applied. The central server may be used to orchestrate the different steps of the algorithms and coordinate all the participating edge devices during the learning process. The central server may be responsible for the edge devices selection at the beginning of the training process and for the aggregation of the received model updates.

For the purposes of machine learning tasks, the fingerprint may be postprocessed to generate input features. In some exemplary embodiments, each bit of the fingerprint may be considered as an independent feature. As an example, the fingerprint resulting from 4 hash functions with output space of 4096 bits may be utilized, then 4*4096=16384 features may be generated. Additionally, or alternatively, each ordered pair of bits of the fingerprint may be considered as an independent feature. Referring again to the previous example in which the fingerprint resulting from 4 hash functions with output space of 4096 bits is used, when 2-tuples of bits are considered as features, then 4*3*(4096*4096)/2=100663296 features will be generated. As yet another example, additional noise imputation may be performed into the resulting bit vector.

On Step 350b, the edge device may be configured to perform a local training of the prediction model, or a version thereof available to the edge device, using pairs of fingerprints and labels available to the edge device that includes a pair of the fingerprint and the label. In order to enable utilization of federated learning, input and output spaces of the prediction model may be required to be fixed.

On Step 360b, the edge device provides information regarding a model update to the predictive model based on the local training performed. Each model update may be designed to adjust model weights of the prediction model. In some exemplary embodiments, additional obfuscation may be performed in this step, in a similar manner as performed in Step 350a of FIG. 1A, to updates privacy-preserving in the federated process.

On Step 370b, the server may be configured to update the prediction model based on the information and updated provided by the edge device.

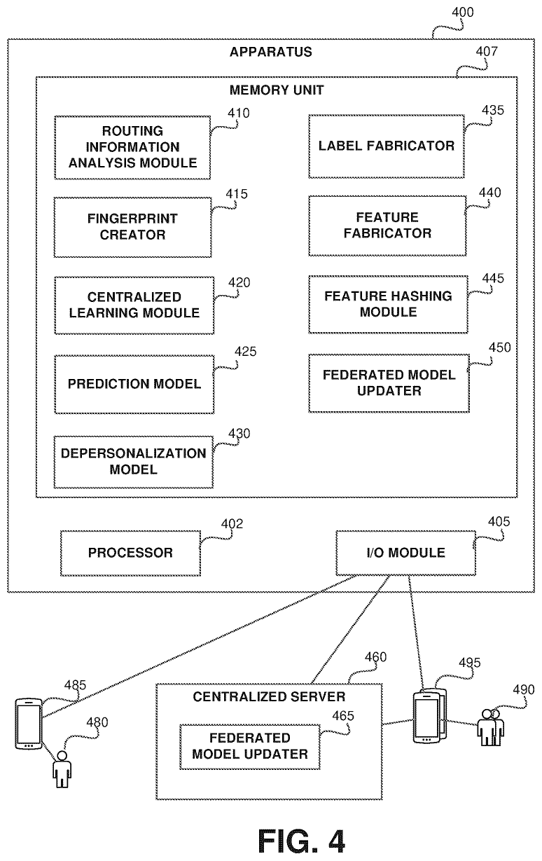

Referring now to FIG. 4 showing a block diagram of an apparatus, in accordance with some exemplary embodiments of the disclosed subject matter.

An Apparatus 400 may be configured to support parallel user interaction with a real-world physical system and a digital representation thereof, in accordance with the disclosed subject matter. In some exemplary embodiments, Apparatus 400 may be configured to obtain routing information of a Device 485 and predict metadata of a User 480 of Device 485 based on the routing information, in accordance with the disclosed subject matter. Additionally or alternatively, Apparatus 400 may be configured to generate and distribute a Prediction Model 425 to be utilized for predicting such metadata, based on training data collected from multiple Edge Devices 495.

In some exemplary embodiments, Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 400 or any of its subcomponents.

In some exemplary embodiments of the disclosed subject matter, Apparatus 400 may comprise an Input/Output (I/O) module 405. I/O Module 405 may be utilized to provide an output to and receive input from an edge device such as Edge Devices 495. As an example, I/O Module 405 may be utilized to obtain network or routing information from Edge Devices 495, providing model updates, or the like.

In some exemplary embodiments, Apparatus 400 may comprise Memory 407. Memory 407 may be a hard disk drive, a Flash disk, a Random-Access Memory (RAM), a memory chip, or the like. In some exemplary embodiments, Memory 407 may retain program code operative to cause Processor 402 to perform acts associated with any of the subcomponents of Apparatus 400.

In some exemplary embodiments, I/O Module 405 may be configured to obtain routing information of a device such as Edge Devices 495, in the training phase, Edge Device 485 in the execution phase, or the like. The routing information may be obtained based on one or more probe packets sent by the device to a server that is connectable to the device via the Internet, such as a server within Apparatus 400 (not shown), or Centralized Server 455 connected thereto, or the like. The routing information may include a series of IP addresses of the series of packet hops until reaching the Internet.

Routing Information Analysis Module 410 may be responsible for analyzing the routing information obtained via I/O Module 405. The routing information may be obtained based on one or more probe packets sent by the device to a server that is connectable to the device via the Internet, such as Centralized Server 460, or directly to Apparatus 400, whereby a series of packet hops was implemented to route the one or more probe packets to Centralized Server 460 or Apparatus 400, respectively.

Fingerprint Creator 415 may be configured to create a fingerprint that describes the architecture of the connection path of the respective device to the Internet, based on the routing information obtained via I/O Module 405, and based on the analysis thereof performed by Routing Information Analysis Module 410. Fingerprint Creator 415 may be configured to generate the fingerprint based on the series of IP addresses of the packet hops or an encoding thereof, such as based on IP addresses associated with N consecutive packet hops from the device in accordance with the routing information.

In some exemplary embodiments, such as in the execution phase, Prediction Model 425 may be configured to determine a label for a Device 485 of User 480. The label may be predicted without exposing the fingerprint to an external device. In some exemplary embodiments, Prediction Model 425 may be generated using Federated Learning Module 450, which collects model updates from Edge Devices 495 and providing the updated to Central Server 460 to be utilized by Federated Model Updater 465. Additionally or alternatively, Edge Devices 495 may be configured to provide the model updates directly to Central Server 460, which may utilize Apparatus 400 for the training, obfuscation, or the like. Additionally or alternatively, Prediction Model 425 may be generated using Centralized Learning Module 420, which uses training data from Edge Devices 495.

Additionally or alternatively, such as in the training phase, Centralized learning module 420 may be configured to train a Prediction Model 425 to determine a label for the fingerprint. The label is indicative of metadata of a user of the device, similar to and based on Users 490 of Edge Devices 495. Prediction Model 425 may be trained using a training dataset that includes pairs of fingerprints and labels, that are obtained from Edge Devices 495 having known labels. The fingerprints of the training dataset may be indicative of a routing information of an edge device to the Internet. In some exemplary embodiments, Centralized learning module 420 may be configured to generate Prediction Model 425 using centralized learning performed on a Central Server 455. The training dataset utilized for training Prediction Model 425 may comprise multiple training data, each of which is obtained from a different edge device like Edge Device 495.

Depersonalization Model 430 may be configured to process the training data by replacing a permanent identifier of the respective edge device with a transient identifier prior to being sent to Central Server 460, thereby preserving privacy of data of the respective edge device. Depersonalization Model 430 may be configured to ensure that sensitive data of Edge Devices 495, or Users 790 thereof is not disclosed, such as by removing any personally identifiable information.

Label Fabricator 435 may be configured to generates labels that can be used to categorize data. Label Fabricator 435 may be configured to generate fabricated labels based on the correct labels reported by Edge Devices 495, to be added for the training data with true fingerprints. Label Fabricator 435 may generate the fabricated labels, using different techniques, such as introducing noise, hashing or the like.

Feature Fabricator 440 may be configured to extract relevant features from the data. Feature Fabricator 440 may be configured to generate fabricated features, such as fabricated fingerprints. Similarly, Feature Fabricator 435 may generate the fabricated Feature, using different techniques, such as introducing noise, hashing or the like. Additionally or alternatively, Feature Fabricator 440 may be configured to utilize Feature Hashing Module 445 to generate the fabricated fingerprints by modifying an IP address of at least one packet hop in the connection path, hashing a representation of the IP series composing the fingerprint, or the like.

Additionally or alternatively, Feature Hashing Module 445 may be configured to operate separately from Feature Fabricator 440, such as by hashing the features of the generated training data prior to been utilized for learning, by one or more machine learning techniques, such as centralized learning performed by Centralized Learning Module 460, or federated learning performed by Federated Model Updater 465 and Centralized Server 460, or the like. As an example, Feature Hashing Module 445 may be configured to converts the extracted features into a compact representation for efficient processing, before being provided to Federated Learning Module 450, to allows Federated Learning Module 450 and Centralized Server 460 to learn from data distributed across multiple sources without actually sharing the data.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a hard disk, a random-access memory (RAM), a read-only memory (ROM), an erasable programmable read-only memory (EPROM or Flash memory), a static random-access memory (SRAM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a Local Area Network (LAN), and a Wide Area Network (WAN). The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, aspect oriented programming language, procedural programming language, or the like. The computer readable program instructions may execute entirely on the user's computer, partly on the user's computer, as a stand-alone software package, partly on the user's computer and partly on a remote computer or entirely on the remote computer or server. The remote computer may be connected to the user's computer through any type of network, including a LAN, a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining routing information of a device, wherein the routing information is obtained based on one or more probe packets sent by the device to a server that is connectable to the device via the Internet, whereby a series of packet hops was implemented to route the one or more probe packets to the server, the routing information includes a series of Internet Protocol (IP) addresses of the series of packet hops until reaching the Internet;
creating, based on the routing information, a fingerprint describing an architecture of connection path of the device to the Internet; and
utilizing a prediction model to determine a label for the fingerprint, wherein the label is indicative of metadata of a user of the device, wherein the prediction model is trained using training dataset that includes pairs of fingerprints and labels using edge devices having known labels, the fingerprints of the training dataset are indicative of a routing information of an edge device to the Internet.

2. The method of claim 1, wherein the fingerprint comprises the series of Internet Protocol (IP) addresses of the series of packet hops or an encoding thereof.

3. The method of claim 1, wherein the fingerprint comprises IP addresses associated with N consecutive packet hops from the device in accordance with the routing information.

4. The method of claim 1, wherein a similarity between two fingerprints is determined based on a size of an identical subset of consecutive packet hops.

5. The method of claim 1, wherein said utilizing the prediction model is performed on the device, to predict the label for the device without exposing the fingerprint to an external device.

6. The method of claim 5 further comprises augmenting prediction of label for the fingerprint using additional features gathered at the device, wherein the additional features are not available to the external device.

7. The method of claim 1, wherein the prediction model is generated using centralized learning performed on a central server, wherein the training dataset comprises multiple training data, each of which are obtained from a different edge device.

8. The method of claim 7, wherein each training data obtained from a respective edge device is processed to replace a permanent identifier of the respective edge device with a transient identifier prior to being sent to the central server, whereby preserving privacy of data of the respective edge device.

9. The method of claim 1, wherein the training dataset includes a partly fabricated training data that was reported by a training edge device, the training edge device having a known correct label, the partly fabricated training data comprises a fingerprint of the training edge device that is paired with several labels, the several labels include the known correct label and at least one incorrect label, whereby preserving the privacy of data of the training edge device during the training process.

10. The method of claim 1, wherein the training dataset includes a partly fabricated training data that was reported by a training edge device, the training edge device having a known correct label and a known correct fingerprint, the partly fabricated training data comprises at least a first pair and a second pair, the first pair comprising the known correct fingerprint and the known correct label, the second pair comprising a fabricated fingerprint and the known correct label, whereby preserving a privacy of data of the training edge device during the training process.

11. The method of claim 1, wherein the training dataset comprises pairs of fabricated fingerprints and labels, wherein a fabricated fingerprint is generated by modifying an IP address of at least one packet hop in the connection path.

12. The method of claim 1, wherein the training dataset includes a partly fabricated training data, wherein fabrication of training data is performed below a predetermined threshold, thereby enabling the prediction model to predict correct labels despite fabricated and incorrect information.

13. The method of claim 1, wherein the prediction model is generated using federated learning performed on a central server, wherein each edge device provides a model update to the predictive model based on pairs of fingerprints and labels available to the edge device, whereby obfuscating training data generated by the respective edge device.

14. An apparatus comprising a processor and coupled memory, said processor being adapted to:
obtain routing information of a device, wherein the routing information is obtained based on one or more probe packets sent by the device to a server that is connectable to the device via the Internet, whereby a series of packet hops was implemented to route the one or more probe packets to the server, the routing information includes a series of Internet Protocol (IP) addresses of the series of packet hops until reaching the Internet;
create, based on the routing information, a fingerprint describing an architecture of connection path of the device to the Internet; and
utilize a prediction model to determine a label for the fingerprint, wherein the label is indicative of metadata of a user of the device, wherein the prediction model is trained using training dataset that includes pairs of fingerprints and labels using edge devices having known labels, the fingerprints of the training dataset are indicative of a routing information of an edge device to the Internet.

15. A computer program product comprising a non-transitory computer readable medium retaining program instruction, which program instructions when read by a processor, cause the processor to:
obtain routing information of a device, wherein the routing information is obtained based on one or more probe packets sent by the device to a server that is connectable to the device via the Internet, whereby a series of packet hops was implemented to route the one or more probe packets to the server, the routing information includes a series of Internet Protocol (IP) addresses of the series of packet hops until reaching the Internet;
create, based on the routing information, a fingerprint describing an architecture of connection path of the device to the Internet; and
utilize a prediction model to determine a label for the fingerprint, wherein the label is indicative of metadata of a user of the device, wherein the prediction model is trained using training dataset that includes pairs of fingerprints and labels using edge devices having known labels, the fingerprints of the training dataset are indicative of a routing information of an edge device to the Internet.
